(19) United States
(12) Patent Application Publication
(10) Pub. No.: US 2013/0107877 A1
(43) Pub. Date: May 2, 2013

(54) IP TELEPHONE SYSTEM AND METHOD

(71) Applicants: Kwon Soo Lee, Gyeonggi-do (KR); Chang Woo Lee, Seoul (KR)

(72) Inventors: Kwon Soo Lee, Gyeonggi-do (KR); Chang Woo Lee, Seoul (KR)

(73) Assignee: MOIMSTONE CO., LTD., Gyeonggi-do (KR)

(21) Appl. No.: 13/807,961

(22) PCT Filed: Jun. 23, 2011
(86) PCT No.: PCT/KR11/04603

§ 371 Date: Jan. 2, 2013

(30) Foreign Application Priority Data
Jul. 2, 2010 (KR) 10-2010-0064012

(51) Int. Cl. H04L 29/06

(52) U.S. Cl. CPC H04L 29/06
USPC 370/352

(57) ABSTRACT

An IP telephone system and method are provided. The IP telephone system includes an IP telephone; and a terminal connected to the IP telephone, determining a line state of the IP telephone and line states of IP telephones connected to other terminals within a sub net to which the terminal belongs and/or at least one other sub net to which the terminal does not belong, updating line state information of IP telephones included in a phonebook list, and transmitting the updated phonebook list to the other terminals.

### TECHNICAL FIELD

The present invention relates to an IP telephone system and method, and more particularly to, a technology of checking line states of IP telephones of the other party to perform a busy lamp field (BLF) function by using a terminal having better system performance than an IP telephone.

### BACKGROUND

Recently, as a communication network has continued to evolve, in addition to a legacy communication network such as a conventional PSTN network, various packet and circuit based wired/wireless communication networks have been provided. A variety of business providers provide a telephone service over such wired/wireless communication networks. In particular, owing to an increase in the Internet access and a broadband service of the Internet communication network, an Internet telephone service using an SIP protocol over a packet based communication network has been spotlighted.

An IP telephone used for the Internet telephone service has a busy lamp field (BLF) function to determine a line state of an IP telephone of the other party. That is, the IP telephone is connected to an exchange or a private automatic branch exchange (PABX) of an Internet telephone service provider and provides a user with information regarding whether the IP telephone of the other party determined by the exchange or the PABX of the Internet telephone service provider is in a state of busy, idle, or hook on by using the BLF function.

However, the IP telephone having the BLF function needs to continuously check states of IP telephones of the other party that are stored in the IP telephone, which causes much traffic, and the IP telephone is likely to be down due to the system overload. These make it difficult to implement the BLF function in the IP telephone, and thus the IP telephone having the BLF function is disadvantageously expensive.

### DETAILED DESCRIPTION OF THE INVENTION

### Technical Problem

The present invention provides an IP telephone system and method for implementing a busy lamp field (BLF) function in a terminal connected to an IP telephone instead of implementing the BLF function in the IP telephone, thereby preventing much traffic from occurring, preventing the IP telephone from being down due to the system overload when the IP telephone checks line states of IP telephones of the other party, and implementing the BLF function at a low price.

### Technical Solution

According to an aspect of the present invention, there is provided an IP telephone system including: an IP telephone; and a terminal connected to the IP telephone, determining a line state of the IP telephone and line states of IP telephones connected to other terminals within a sub net to which the terminal belongs and/or at least one other sub net to which the terminal does not belong, updating line state information of IP telephones included in a phonebook list, and transmitting the updated phonebook list to the other terminals.

The system performance of the IP telephone and the IP telephones connected to the other terminals within the sub net to which the terminal belongs and/or the at least one other sub net to which the terminal does not belong may be lower than the system performance of each of the connected terminals, wherein the system performance is compared in terms of a CPU speed and capacity of a storage device.

According to another aspect of the present invention, there is provided a terminal including: a third network interface connecting the terminal to the Internet; a fourth network interface connecting the terminal and an IP telephone; a phonebook storage unit storing a phonebook list including a line state of the IP telephone and line states of IP telephones connected to terminals within a sub net to which the terminal belongs and/or at least one other sub net to which the terminal does not belong; a line state determining unit determining the line state of the IP telephone connected to the terminal and the line states of the IP telephones connected to the other terminals within the sub net to which the terminal belongs and/or the at least one other sub net to which the terminal does not belong; a phonebook information updating unit updating the phonebook list stored in the phonebook storage unit by using the line state of the IP telephone connected to the terminal and the line states of the IP telephones connected to the other terminals within the sub net to which the terminal belongs and/or the at least one other sub net to which the terminal does not belong that are determined by the line state determining unit; and a phonebook information transmitting unit transmitting the phonebook list updated by the phonebook information updating unit to the other terminals within the sub net to which the terminal belongs and/or the at least one other sub net to which the terminal does not belong.

According to another aspect of the present invention, there is provided an IP telephone method including: determining a line state of an IP telephone connected to a terminal and line states of IP telephones connected to other terminals within a sub net to which the terminal belongs and/or at least one other sub net to which the terminal does not belong, wherein the determining is performed by the terminal; updating line state information of IP telephones included in the phonebook list by using the line state of the IP telephone connected to the terminal and the line states of the IP telephones connected to the other terminals within the sub net to which the terminal belongs and/or the at least one other sub net to which the terminal does not belong that are determined in the determining of the line state, and transmitting the updated phonebook list to the other terminals within the sub net to which the terminal belongs and/or the at least one other sub net to which the terminal does not belong, wherein the updating and transmitting are performed by the terminal; and updating line state information of IP telephones included in phonebook lists of the other terminals by using the line state information of the IP telephones included in the phonebook list received from the terminal, wherein the updating is performed by the other terminals within the sub net to which the terminal belongs and/or the at least one other sub net to which the terminal does not belong.

### Advantageous Effects

According to the IP telephone system and method of the embodiments of the present invention, a busy lamp field (BLF) function is implemented in a terminal connected to an IP telephone instead of implementing the BLF function in the IP telephone, thereby preventing much traffic from occurring, preventing the IP telephone from being down due to the system overload when the IP telephone checks line states of IP telephones of the other party, and implementing the BLF function at a low price.

### DESCRIPTION OF THE DRAWINGS

FIG. 1 is a block diagram of a configuration of an IP telephone system according to an embodiment of the present invention;

FIG. 2 is a block diagram of a configuration of a terminal according to an embodiment of the present invention; and

FIG. 3 is a flowchart of an IP telephone method according to an embodiment of the present invention.

### BEST MODE

Hereinafter, the present invention will be described more fully with reference to the accompanying drawings, in which exemplary embodiments of the invention are shown. While describing the present invention, detailed descriptions about related well known functions or configurations that may blur the points of the present invention are omitted. In addition, all terms mentioned throughout this disclosure are the ones generally defined based on the functions of what they represent in the present invention, and thus, their definitions may vary depending on user's intent or customs. Therefore, those terms should be defined based on the content of the present invention presented herein the present disclosure.

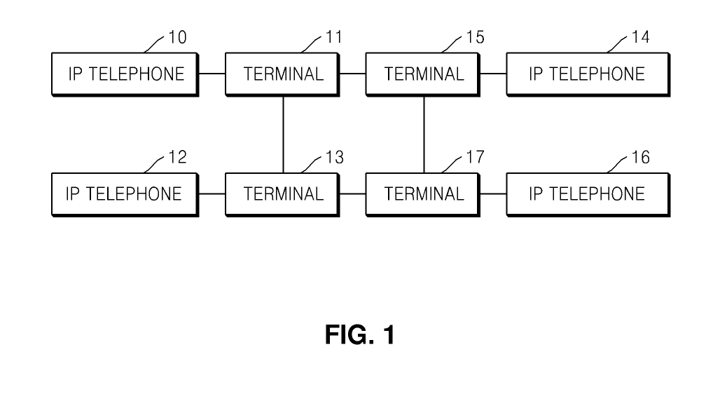

FIG. 1 is a block diagram of a configuration of an IP telephone system according to an embodiment of the present invention.

As shown in FIG. 1, the IP telephone system according to an embodiment of the present invention includes a plurality of IP telephones 10, 12, 14, and 16 and a plurality of terminals 11, 13, 15, and 17 respectively connected to the IP telephones 10, 12, 14, and 16. The IP telephones 10, 12, 14, and 16 and the terminals 11, 13, 15, and 17 perform the same operations, and thus the operation of the IP telephone system according to an embodiment of the present invention will now be described based on the IP telephone 10 and the terminal 11.

The IP telephone 10 includes two network interfaces, is connected to the Internet through a first network interface (not shown) to perform a voice over Internet protocol (VOIP) communication with another IP telephone, is connected to the terminal 11 through a second network interface (not shown) to receive line states of IP telephones included in a phonebook list from the terminal 11. In this regard, the line states of the IP telephones may be one of states of busy, idle, and hook on.

The terminal 11 includes two network interface and is connected to the Internet through a third network interface (not shown) and is connected to the IP telephone 10 through a fourth network interface (not shown).

That is, the terminal 11 determines line states of IP telephones connected to other terminals within a sub net to which the terminal 11 belongs and/or at least one other sub net to which the terminal 11 does not belong and a line state of the IP telephone 11 connected to the terminal 11 through the Internet, updates the phonebook list by using the determined line states of the IP telephones included in the phonebook list and the determined line state of the IP telephone 10 connected to the terminal 11, and transmits the updated phonebook list to the other terminals within the sub net to which the terminal 11 belongs and/or the at least one other sub net to which the terminal 11 does not belong. Accordingly, the other terminals synchronize line state information of IP telephones included in phonebook lists of the other terminals by using line state information of the IP telephones included in the phonebook list received from the terminal 11.

In this regard, the IP telephone 10 and the IP telephones connected to the other terminals within the sub net to which the terminal 11 belongs and/or the at least one other sub net to which the terminal 11 does not belong may be IP telephones that implement a busy lamp field (BLF) function of determining and outputting line state information of other IP telephones or do not implement the BLF function.

The terminal 11 has a higher system performance, for example, CPU processing speed, capacity of a storage device, etc. than the IP telephone 10, and may be a personal computer (PC). The system performance of the IP telephones connected to the other terminals within the sub net to which the terminal 11 belongs and/or the at least one other sub net to which the terminal 11 does not belong is lower than the system performance of each of the connected terminals. Thus, without performing the BLF function in an IP telephone having a low system performance, a terminal having a higher system performance than the IP telephone determines line states of other IP telephones included in a phonebook list to perform the BLF function, thereby manufacturing the IP telephone that does not implement the BLF function at a low price, reducing much traffic occurring in the IP telephone due to a line check, and preventing a system from being down due to the line check.

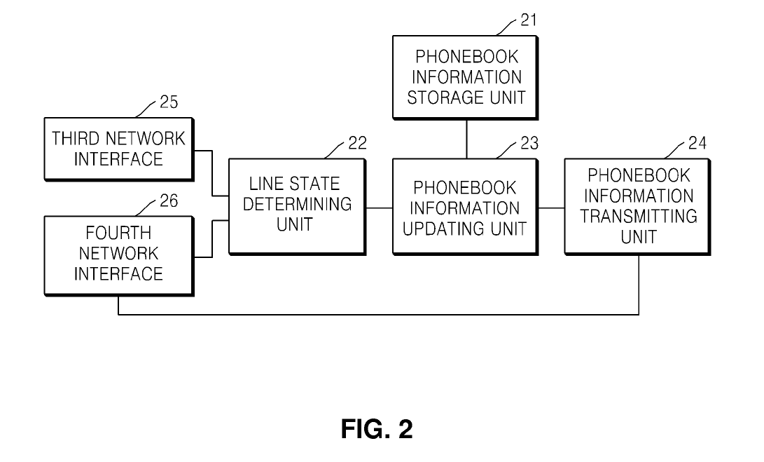

FIG. 2 is a block diagram of a configuration of a terminal according to an embodiment of the present invention.

As shown in FIG. 2, the terminal includes a phonebook storage unit 21, a line state determining unit 22, a phonebook information updating unit 23, a phonebook information transmitting unit 24, a third network interface 25, and a fourth network interface 26.

The third network interface 25 is used to connect the terminal to the Internet. The fourth network interface 26 is used to connect the terminal and an IP telephone.

The phonebook storage unit 21 stores a phonebook list including a line state of the IP telephone connected to the terminal and line states of IP telephones connected to terminals within a sub net to which the terminal belongs and/or at least one other sub net to which the terminal does not belong. In this regard, the IP telephones included in the phonebook list may be IP telephones stored by a user to determine line states by using a BLF function.

The line state determining unit 22 determines the line state of the IP telephone connected to the terminal through the fourth network interface 26 and the line states of the IP telephones connected to the other terminals within the sub net to which the terminal belongs and/or the at least one other sub net to which the terminal does not belong through the third network interface 25.

The phonebook information updating unit 23 updates the phonebook list stored in the phonebook storage unit 21 by using the line state of the IP telephone connected to the terminal and the line states of the IP telephones connected to the other terminals within the sub net to which the terminal belongs and/or the at least one other sub net to which the terminal does not belong that are determined by the line state determining unit 22.

The phonebook information transmitting unit 24 transmits the phonebook list updated by the phonebook information updating unit 23 to the other terminals within the sub net to which the terminal belongs and/or the at least one other sub net to which the terminal does not belong.

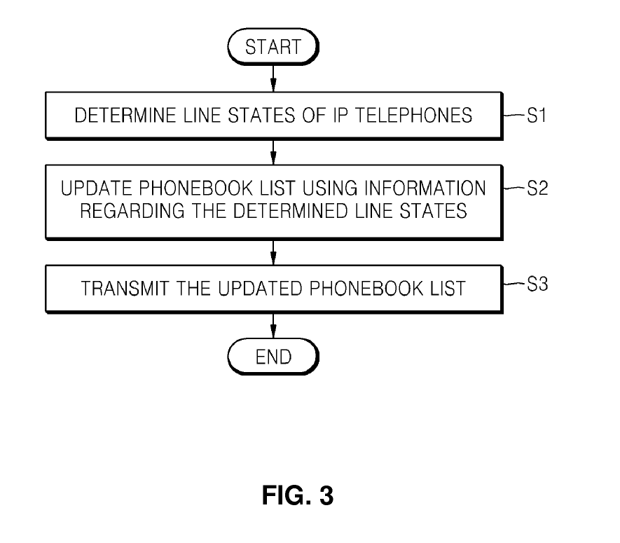

FIG. 3 is a flowchart of an IP telephone method performed by an IP telephone system according to an embodiment of the present invention.

A terminal determines a line state of an IP telephone connected to the terminal and line states of IP telephones connected to other terminals within a sub net to which the terminal belongs and/or at least one other sub net to which the terminal does not belong (operation S1).

Thereafter, the terminal updates line state information of IP telephones included in the phonebook list by using the line state of the IP telephone connected to the terminal and the line states of the IP telephones connected to the other terminals within the sub net to which the terminal belongs and/or the at least one other sub net to which the terminal does not belong that are determined in operation S1, and transmits the updated phonebook list to the other terminals within the sub net to which the terminal belongs and/or the at least one other sub net to which the terminal does not belong (operation S2).

The other terminals within the sub net to which the terminal belongs and/or the at least one other sub net to which the terminal does not belong update line state information of IP telephones included in phonebook lists of the other terminals by using the line state information of the IP telephones included in the phonebook list received from the terminal (operation S3).

While the present general inventive concept has been particularly shown and described with reference to exemplary embodiments thereof, it will be understood by those of ordinary skill in the art that various changes in form and details may be made therein without departing from the spirit and scope of the present general inventive concept as defined by the following claims.

### INDUSTRIAL APPLICABILITY

The present invention can be applied to an Internet telephone development field.

1. An IP telephone system comprising:
an IP telephone; and
a terminal connected to the IP telephone, determining a line state of the IP telephone and line states of IP telephones connected to other terminals within a sub net to which the terminal belongs and/or at least one other sub net to which the terminal does not belong, updating line state information of IP telephones included in a phonebook list, and transmitting the updated phonebook list to the other terminals.

2. The IP telephone system of claim 1, wherein the system performance of the IP telephone and the IP telephones connected to the other terminals within the sub net to which the terminal belongs and/or the at least one other sub net to which the terminal does not belong is lower than the system performance of each of the connected terminals,
wherein the system performance is compared in terms of a CPU speed and capacity of a storage device.

3. A terminal comprising:
a third network interface connecting the terminal to the Internet;
a fourth network interface connecting the terminal and an IP telephone;
a phonebook storage unit storing a phonebook list including a line state of the IP telephone and line states of IP telephones connected to terminals within a sub net to which the terminal belongs and/or at least one other sub net to which the terminal does not belong;
a line state determining unit determining the line state of the IP telephone connected to the terminal and the line states of the IP telephones connected to the other terminals within the sub net to which the terminal belongs and/or the at least one other sub net to which the terminal does not belong;
a phonebook information updating unit updating the phonebook list stored in the phonebook storage unit by using the line state of the IP telephone connected to the terminal and the line states of the IP telephones connected to the other terminals within the sub net to which the terminal belongs and/or the at least one other sub net to which the terminal does not belong that are determined by the line state determining unit; and
a phonebook information transmitting unit transmitting the phonebook list updated by the phonebook information updating unit to the other terminals within the sub net to which the terminal belongs and/or the at least one other sub net to which the terminal does not belong.

4. The terminal of claim 3, wherein the system performance of the IP telephone and the IP telephones connected to the other terminals within the sub net to which the terminal belongs and/or the at least one other sub net to which the terminal does not belong is lower than the system performance of each of the connected terminals,
wherein the system performance is compared in terms of a CPU speed and capacity of a storage device.

5. An IP telephone method comprising:
determining a line state of an IP telephone connected to a terminal and line states of IP telephones connected to other terminals within a sub net to which the terminal belongs and/or at least one other sub net to which the terminal does not belong, wherein the determining is performed by the terminal;
updating line state information of IP telephones included in the phonebook list by using the line state of the IP telephone connected to the terminal and the line states of the IP telephones connected to the other terminals within the sub net to which the terminal belongs and/or the at least one other sub net to which the terminal does not belong that are determined in the determining of the line state, and transmitting the updated phonebook list to the other terminals within the sub net to which the terminal belongs and/or the at least one other sub net to which the terminal does not belong, wherein the updating and transmitting are performed by the terminal; and
updating line state information of IP telephones included in phonebook lists of the other terminals by using the line state information of the IP telephones included in the phonebook list received from the terminal, wherein the updating is performed by the other terminals within the sub net to which the terminal belongs and/or the at least one other sub net to which the terminal does not belong.
